(19) United States
(12) Patent Application Publication
(10) Pub. No.: US 2008/0227890 A1
(43) Pub. Date: Sep. 18, 2008

(54) Cement Grinding Aid

(75) Inventors: Urs Maeder, Frauenfeld (CH); Dieter Honert, Dielheim (DE); Beat Marazzani, Oberengstringen (CH)

Correspondence Address: OLIFF & BERRIDGE, PLC, P.O. BOX 320850, ALEXANDRIA, VA, 22320-4850, US

(73) Assignee: SIKA TECHNOLOGY AG, BAAR (CH)

(21) Appl. No.: 11/630,136

(22) PCT Filed: Jun. 21, 2005
(86) PCT No.: PCT/EP05/52883

§ 371 Date: Feb. 4, 2008

(30) Foreign Application Priority Data
Jun. 21, 2004 (EP) 04102826.7

(51) Int. Cl. C04B 24/26

(52) U.S. Cl. 524/5

(57) ABSTRACT

The invention relates to an aqueous polymer composition which is used in the form of a cement grinding aid and makes it possible to effectively reduce the grinding time and to obtain cements exhibiting excellent characteristics. A cement grinding aid containing a combination of polymer A and known cement grinding aids is also disclosed.

### TECHNICAL FIELD

The invention relates to the field of cement grinding aids.

### STATE OF THE ART

The production of cement is a very complex process. Cement is known to be very sensitive toward water, irrespective of whether it is present in the liquid or gaseous state, since cement sets hydraulically, i.e. it hardens under the influence of water within a short time to give a very stable solid body. A central step in cement production is the grinding of the clinker. Since clinkers are very hard, the comminution is very demanding. For the properties of the cement, it is important that it is present as a fine powder. The fineness of the cement is therefore an important quality feature. In order to facilitate the comminution to powder form, so-called cement grinding aids are used. This greatly reduces the grinding times and energy costs. Such cement grinding aids are typically selected from the class comprising glycols such as alkylene glycols, amines or amino alcohols.

For example, U.S. Pat. No. 5,084,103 describes trialkanolamines, such as triisopropanolamine (TIPA) or N,N-bis(2-hydroxyethyl)-N-(2-hydroxypropyl)amine and tris(2-hydroxybutyl)amine as grinding aids for clinkers.

In addition, water-soluble polycarboxylates are known from WO 97/10308 or EP 0 100 947 A1 as grinding aids for the production of aqueous suspensions of minerals such as lime or pigments, especially for use in papermaking. US 2002/0091177 A1 describes the use of polymers composed of ethylenically unsaturated monomers as a grinding aid for producing aqueous suspensions of ground mineral fillers. This document further discloses that a cement which is mixed with such an aqueous suspension leads to improved early strength. However, none of these documents discloses a cement grinding aid.

The use of so-called concrete plasticizers has been known for some time. For example, EP 1 138 697 B1 or EP 1 061 089 B1 discloses that (meth)acrylate polymers with ester and optionally amide side chains are suitable as concrete plasticizers. In this case, this concrete plasticizer is added to the cement as an additive or added to the cement before the grinding, and leads to high plastification, for example reduction in the water demand, of the concrete or mortar produced therefrom.

### DESCRIPTION OF THE INVENTION

It has now been found that, surprisingly, aqueous compositions comprising at least one polymer A of the formula (I) can also be used as cement grinding aids, especially in combination with amino alcohols. It has further been found that, surprisingly, the combination of the polymers A with the customary cement grinding aids can remedy or greatly reduce the disadvantages of the known grinding aids without the advantageous effects of the polymer A being lost.

### Ways of Performing the Invention

The present invention relates to the use of aqueous compositions as cement grinding aids. The aqueous composition comprises at least one polymer A of the formula (I).

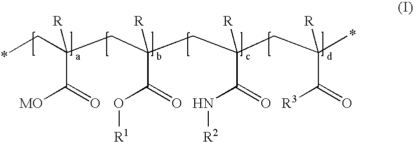

In this formula, M are each independently H⁺, alkali metal ion, alkaline earth metal ion, di- or trivalent metal ion, ammonium ion or organic ammonium groups. The term “each independently” means here and hereinafter in each case that a substituent may have different available definitions in the same molecule. For example, the polymer A of the formula (I) can simultaneously have carboxylic acid groups and sodium carboxylate groups, which means that H⁺ and Na⁺ each independently mean for R₁ in this case.

It is clear to the person skilled in the art firstly that the group is a carboxylate to which the ion M is bonded, and that secondly, in the case of polyvalent ions M, the charge has to be balanced by counterions.

Moreover, the substituents R are each independently hydrogen or methyl. This means that the polymer A is a substituted poly(acrylate), poly(methacrylate) or a poly((meth)acrylate).

In addition, the substituents R¹ and R² are each independently C₁- to C₂₀-alkyl, cycloalkyl, alkylaryl or -[AO]_{N}—R⁴. In this formula, A is a C₂- to C₄-alkylene group and R⁴ is a C₁- to C₂₀-alkyl, cyclohexyl or alkyl-aryl group, while n is from 2 to 250, in particular from 8 to 200, more preferably from 11 to 150.

In addition, the substituents R³ are each independently —NH₂, —NR⁵R⁶, —OR⁷NR⁸R⁹. In these substituents, R⁵ and R⁶ are each independently H or a C₁- to C₂₀-alkyl, cyclo-alkyl or alkylaryl or aryl group, or a hydroxyalkyl group or an acetoxyethyl (CH₃—CO—O—CH₂—CH₂—) or a hydroxyisopropyl (HO—CH(CH₃)—CH₂—) or an acetoxy-isopropyl group (CH₃—CO—O—CH(CH₃)—CH₂—), or R⁵ and R⁶ together form a ring, of which the nitrogen is part, to form a morpholine or imidazoline ring. Moreover, the substituents R⁸ and R⁹ here are each independently a C₁- to C₂₀-alkyl, cycloalkyl, alkylaryl, aryl or a hydroxyalkyl group, and R⁷ is a C₂-C₄-alkylene group.

Finally, the indices a, b, c and d are molar ratios of these structural elements in the polymer A of the formula (I). These structural elements are in a ratio relative to one another of

a/b/c/d=(0.1-0.9)/(0.1-0.9)/(0-0.8)/(0-0.3), in particular a/b/c/d=(0.1-0.9)/(0.1-0.9)/(0-0.5)/(0-0.1), preferably a/b/c/d=(0.1-0.9)/(0.1-0.9)/(0-0.3)/(0-0.06), while the sum of a+b+c+d=1. The sum of c+d is preferably greater than 0.

The polymer A can be prepared by free-radical polymerization of the particular monomers

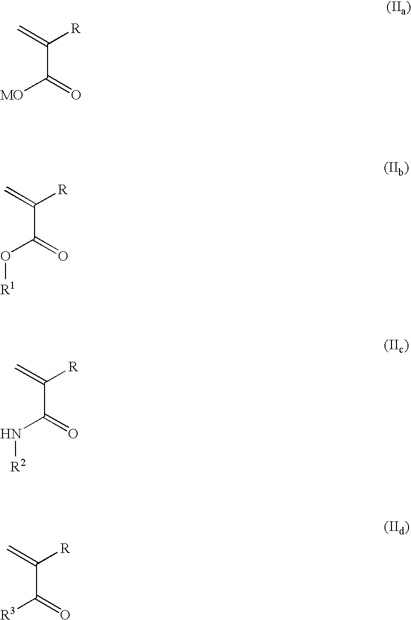

or by a so-called polymer-analogous reaction of a polycarboxylic acid of the formula (III)

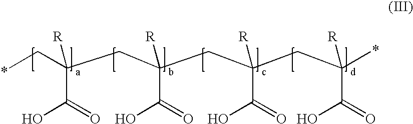

In the polymer-analogous reaction, the polycarboxylic acid is esterified or amidated with the corresponding alcohols, amines. Details of the polymer-analogous reaction are disclosed, for example, in EP 1 138 697 B1 on page 7 line 20 to page 8 line 50, and in its examples, or in EP 1 061 089 B1 on page 4 line 54 to page 5 line 38 and in its examples. In a variation thereof, as described in EP 1 348 729 A1 on page 3 to page 5 and in its examples, the polymer A can be prepared in the solid state of matter.

It has been found that a particularly preferred embodiment of the polymer is that in which c+d>0, in particular d>0. A particularly advantageous R³ radical has been found in particular to be —NH—CH₂—CH₂—OH. Such polymers A have a chemically bonded ethanolamine, which constitutes an extremely efficient corrosion inhibitor. The chemical attachment of the corrosion inhibitor greatly reduces the odor in comparison to where it is merely admixed. Moreover, it has been found that such polymers A also have significantly greater plastification properties.

The aqueous composition is prepared by adding water in the preparation of the polymer A of the formula (I) or by subsequent mixing of polymer A of the formula (I) with water.

Typically, the proportion of the polymer A of the formula (I) is from 10 to 90% by weight, in particular from 25 to 50% by weight, based on the weight of the aqueous composition.

Depending on the type of polymer A of the formula (I), a dispersion or a solution is formed. Preference is given to a solution.

The aqueous composition may comprise further constituents. Examples thereof are solvents or additives as are customary in concrete technology, especially surfactants, heat and light stabilizers, dyes, defoamers, accelerants, retardants, corrosion inhibitors, air pore formers.

In one embodiment of the invention, the aqueous composition used as the cement grinding aid—referred to hereinafter as CA—apart from at least one polymer A of the formula (I), does not comprise any further grinding aids.

In a preferred embodiment of the invention, the aqueous composition used as a cement grinding aid—referred to hereinafter as CAGA—in addition to at least one polymer A of the formula (I) as has been described above, comprises at least one further grinding aid. This further grinding aid is selected in particular from the group comprising glycols, organic amines and ammonium salts of organic amines with carboxylic acids.

Suitable glycols are in particular alkylene glycols, in particular of the formula OH—(CH₂—CH₂—O)ₙ—CH₂CH₂—OH where n=0-20, in particular 0, 1, 2 or 3.

Suitable organic amines are especially alkanolamines, in particular trialkanolamines, preferably tri-isopropanolamine (TIPA) or triethanolamine (TEA).

The aqueous composition is added to the clinker before the grinding and then ground to give the cement. In principle, the aqueous composition can also be added during the grinding process. However, preference is given to addition before the grinding. The addition can be effected before, during or after the addition of gypsum and if appropriate other grinding additives, for example lime, blast furnace slag, fly ash or pozzolana.

The aqueous composition may also be used for the production of blend cements. To this end, individual cements which are each prepared separately by grinding with the aqueous composition can be mixed, or a mixture of a plurality of cement clinkers is ground with the aqueous composition in order to obtain a blend cement.

It will be appreciated that it is possible—even if this is not preferred—instead of an aqueous composition CAGA, also to combine and to use an aqueous composition CA together with a grinding aid, which means that this aqueous composition is used separately from the further grinding aid in the grinding.

The aqueous composition is preferably added to the clinker such that the polymer A of the formula (I) is 0.001-1.5% by weight, in particular between 0.005 and 0.2% by weight, preferably between 0.005 and 0.1% by weight, based on the clinker to be ground.

It has therefore been found, inter alia, that even significantly smaller concentrations of the polymer A in relation to the cement can be used effectively as cement grinding aids than they are known to be added to the cement as a plasticizing additive, i.e. typically 0.2 to 1.5% polymer A.

The grinding process is effected typically in a cement grinder. However, it is also possible in principle to use other grinders as known in the cement industry. Depending on the grinding time, the cement has different fineness. The fineness of cement is typically reported in cm²/g according to Blaine. On the other hand, the particle size distribution is also relevant to practice for the fineness. Such particle size analyses are typically determined by laser granulometry or air jet sieves.

The use of the inventive aqueous composition allows the grinding time to achieve the desired fineness to be reduced. The energy costs reduced as a result make the use of these coment grinding aids economically very interesting.

It has been found that the aqueous compositions are very suitable as cement grinding aids. It is possible to use them to produce a wide variety of different cements from clinker, especially those cements CEM-I (Portland cement), CEM II and CEM III (blast furnace cement) classified according to DIN EN 197-1. Preference is given to CEM-I.

The addition of the aqueous compositions reduced, for example, the grinding time up to achievement of a particular Blaine fineness. The use of the inventive aqueous composition thus allows the grinding time to achieve the desired fineness to be reduced. The energy costs reduced as a result make the use of these cement grinding aids economically very interesting.

It has also been found that, when aqueous compositions CA are used, only a small amount of, if any, air enters the hydraulically setting compositions, especially mortars, formulated with the cement, whereas it is present to a particularly high degree in the case of use of alkanolamines as a grinding aid.

Moreover, it has been found that the increase in the water demand found in the case of alkanolamines does not occur in the case of aqueous compositions CA, or this is even reduced in comparison to the cement entirely without grinding aid.

It has also been found that, surprisingly, a combination of polymer A of the formula (I) with a further grinding aid in an aqueous composition CAGA affords a cement grinding aid which combines the advantages of the polymer A and of the grinding aid, or rather reduces or even remedies their disadvantages.

For example, it has been found that an aqueous composition CAGA comprising polymer A and alkanolamine is an excellent grinding aid, but that the cement thus produced—compared with a cement with only alkanolamine as a grinding aid—also has a greatly reduced water demand and that excellent early strengths, can be achieved.

Furthermore, it has been found, for example, that an aqueous composition CAGA comprising polymer A and an alkylene glycol constitutes an excellent grinding aid and the cement thus produced has excellent hardening properties.

A particular advantageous aqueous composition CAGA has been found to be one comprising polymer A and an alkanolamine and also an alkylene glycol. Such compositions have been found to be extremely efficient grinding aids. The cements thus produced have a large extent of spreading and especially an excellent early strength.

The cement ground in this way, like any other ground cement, finds wide use in concrete, mortars, casting materials, injections or renders.

When relatively large amounts of polymer A are added to the cement before the grinding of the clinker, the plasticizer properties known from polymers A are evident after they have been blended with water. It is thus possible in a further preferred embodiment of the invention to add sufficient polymer A optionally with a further grinding aid, in the form of an aqueous composition, to the clinker actually before the grinding, as are typically added to the cement as an additive in order to achieve a desired plastification in contact with water. Typically, this amount is from 0.2 to 1.5% by weight of polymer A in relation to the cement. Thus, in this embodiment, no subsequent admixing of a plasticizer is necessary and a working step is therefore saved for the user of the cement. Such a cement therefore constitutes a ready-to-use product which can be produced in large amounts.

### EXAMPLES

### Polymers A Used

TABLE 1
Abbreviations used

| Abbreviation | Meaning | Mw* |
|---|---|---|
| PEG500 | Polyethylene glycol without | 500 g/mol |
| | terminal OH groups | |
| PEG1000 | Polyethylene glycol without | 1000 g/mol |
| | terminal OH groups | |
| PEG1100 | Polyethylene glycol without | 1100 g/mol |
| | terminal OH groups | |
| PEG2000 | Polyethylene glycol without | 2000 g/mol |
| | terminal OH groups | |
| PEG3000 | Polyethylene glycol without | 3000 g/mol |
| | terminal OH groups | |
| PPG600 | Polypropylene glycol without | 600 g/mol |
| | terminal OH groups | |
| PPG800 | Polypropylene glycol without | 800 g/mol |
| | terminal OH groups | |
| EO-PO(50/50)2000 | Block copolymer formed from | 2000 g/mol |
| | ethylene oxide and propylene | |
| | oxide in a ratio of 50:50 | |
| | without terminal OH groups | |

*MW = mean molecular weight

The polymers A specified in Table 2 were prepared by means of polymer-analogous reaction from the particular poly(meth)acrylic acids with the corresponding alcohols and/or amines in a known manner. The polymers A-1 to A-12 are present in partly NaOH-neutralized form (M=H⁺, Na⁺).

The polymers A are used as cement grinding aids as aqueous solutions. The content of the polymer is 30% by weight (A-4), 35% by weight (A-2) or 40% by weight (A-1, A-3, A-5 to A-12). These aqueous solutions are referred to as A-1L, A-2L, A-3L, A-4L, A-5L, A-6L, A-7L, A-8L, A-9L, A-10L, A-11L and A-12L. The concentrations specified for A in the tables which follow are each based on the content of polymer A.

TABLE 2
Polymers A correspond to the formula (I) where M = H⁺, Na⁺

| | R = | R¹ = | | R² = | R³ = | a/b/c/d = | Mw |
|---|---|---|---|---|---|---|---|
| A-1 | H | -PEG1000-OCH₃ | 65: | -EO/PO(50/50)2000-OCH₃ | | 0.640/0.358/0.002/0.000 | 72 000 |
| | | -PEG3000-OCH₃ | 35^{†} | | | | |
| A-2 | CH₃ | -PEG1000-OCH₃ | | | | 0.750/0.250/0.000/0.000 | 24 000 |
| A-3 | H | -PEG1000-OCH₃ | | -EO/PO(50/50)2000-OCH₃ | | 0.610/0.385/0.005/0.000 | 35 000 |
| A-4 | CH₃ | -PEG1000-OCH₃ | | -EO/PO(50/50)2000-OCH₃ | | 0.650/0.348/0.002/0.000 | 32 000 |
| A-5 | H | -PEG1100-OCH₃ | | | | 0.750/0.250/0.000/0.000 | 25 000 |
| A-6 | H | -PEG1000-OCH₃ | | -PEG500-OCH₃ | | 0.670/0.320/0.010/0.000 | 16 000 |
| A-7 | H | -PEG1000-OCH₃: | 65: | -EO/PO(50/50)2000-OCH₃ | —O—CH₂—CH₂—N(CH₃)₂ | 0.640/0.348/0.002/0.010 | 53 000 |
| | | -PEG3000-OCH₃ | 35† | | | | |
| A-8 | H | -PEG1100-OCH₃ | | -PPG600-O-n-butyl | —O—CH₂—CH₂—N(n-butyl)₂ | 0.600/0.340/0.050/0.010 | 52 000 |
| A-9 | CH₃ | -PEG1100-OCH₃: | 60: | -PPG800-O-n-butyl | —O—CH₂—CH₂—N(CH₃)₂ | 0.740/0.230/0.020/0.010 | 35 000 |
| | | -PEG3000-OCH₃ | 40^{†} | | | | |
| A-10 | CH₃ | -PEG1000-OCH₃ | 80: | | —N(CH₂—CH₂—OH)₂ | 0.650/0.348/0.00/0.002 | 48 000 |
| | | -PEG3000-OCH₃ | 20^{†} | | | | |

| A-11 | CH₃ | | -PEG1000-OCH₃ | -EO/PO(50/50)2000-OCH₃ | —NH—(CH₂—CH₂—OH) | 0.59/0.359/0.001/0.050 | 32 000 |
|---|---|---|---|---|---|---|---|
| A-12 | | Structural | -PEG2000-OCH₃ | -PEG500-OCH₃ | | 0.850/0.148.0.020/0.000 | 25 000 |
| | | e.* | | | | | |
| | H | a | | | | | |
| | CH₃ | b, c | | | | | |

*Structural e. = structural element
^{†}molar ratio

### Further Cement Grinding Aids

TABLE 3
Further cement grinding aids

| | |
|---|---|
| TEA | Triethanolamine |
| TIPA | Triisopropanolamine |
| DEG | Diethylene glycol |

### Clinkers Used

TABLE 4
Clinkers used

| | |
|---|---|
| K-1 | Standard clinker for CEM I |
| | HeidelbergCement, Leimen works, Germany |
| K-2 | Clinker for CEM II/B-M(S-LL) |
| | HeidelbergCement, Lengfurt works, Germany |
| K-3 | Clinker for CEM I |
| | Buzzi Unicem S.p.A., Robilante works, Italy |

### Grinding of the Clinker Without Sulfate Carrier

The clinker was initially crushed to a particle size of approx. 4 mm. The concentration of different polymers A specified in Table 5, based on the clinker, were added to the clinker (400 g) and, without addition of gypsum, ground in a laboratory ball mill from Fritsch without external heating at a rotational speed of 400 revolutions per minute.

Grinding of the Clinker with Sulfate Carrier

20-25 kg of a mixture of the particular clinker and a sulfate carrier for the cement optimized in each case were mixed and blended with the particular grinding aid, or without grinding aid, in the dosage specified in Tables 6 to 10, and ground in a heatable ball mill from Siebtechnik at a temperature of from 100 to 120° C. In addition to the grinding time and the sieve residue, further typical cement properties were determined with the ground cement.

### Test Methods

grinding time₄₅₀₀: the time was determined until the mixture had attained a Blaine fineness of 4500 cm²/g after grinding in the ball mill.

fineness: the fineness was determined according to Blaine by means of a Blaine machine from Wasag Chemie.

sieve residue: cement which had been ground to a Blaine fineness of 4500 cm²/g was used to determine the sieve residue of the fraction of particles having a particle size of greater than 32 micrometers by means of an air-jet sieve from Alpine Hosokawa.

sieve residue₄₀₀₀: cement which had been ground to a Blaine fineness of 4000 cm²/g was used to determine the sieve residue of the fraction of particles having a particle size of greater than 32 micrometers by means of an air-jet sieve from Alpine Hosokawa.

water demand: the water demand for so-called “standard stiffness” was determined to EN 196 on cement lime.

flow table spread: the flow table spread was determined to EN196 on a standard mortar (water/cement=0.5).

air content: the air content was determined according to EN 196.

compressive strength: the compressive strength of the hardened prisms was determined to EN 196.

The results of the inventive examples and comparative examples shown hereinafter all derive in each case from a test series performed in immediate succession, all of which are compiled in the same table.

### Comparison of Different Polymers A as Cement Grinding Aids

### Clinker: K-3 Without Sulfate Carrier

TABLE 5
Ground clinkers without sulfate carrier.

| | Ref. | | | | |
|---|---|---|---|---|---|
| Designation | 1-1 | 1-1 | 2-1 | 3-1 | 4-1 |
| Grinding aid | — | A-1 | A-2 | A-3 | A-4 |
| Concentration | | 0.02 | 0.0175 | 0.02 | 0.015 |
| [% by wt] | | | | | |
| Blaine | | | | | |
| fineness | | | | | |
| [cm²/g] | | | | | |
| Grinding time | 1760 | 2130 | 2180 | 2350 | 2180 |
| 10 min. | | | | | |
| Δ_{ref} | | 21% | 24% | 34% | 24% |
| Grinding time | 2560 | 3010 | 3110 | 3230 | 3110 |
| 15 min. | | | | | |
| Δ_{ref} | | 18% | 21% | 26% | 21% |
| Grinding time | 3200 | 3780 | 3790 | 3960 | 3760 |
| 20 min. | | | | | |
| Δ_{ref} | | 18% | 18% | 24% | 18% |

* based on clinker.

### Comparison of Different Polymers A in Comparison to Alkanolamines

Clinker: K-1 with Sulfate Carrier

TABLE 6
Polymers A as grinding aids.

| | Ref. | Ref. | Ref. | | |
|---|---|---|---|---|---|
| Designation | 1-2 | 2-2 | 3-2 | 2-2 | 3-2 |
| Grinding aid | — | TEA | TIPA | A-2 | A-4 |
| Concentration | | 0.024 | 0.0255 | 0.0105 | 0.009 |
| [% by wt] | | | | | |
| Blaine | | | | | |
| fineness | | | | | |
| [cm²/g] | | | | | |
| Grinding time | 2180 | 2270 | 2280 | 2180 | 2110 |
| 30 min. | | | | | |
| Δ_{ref} | | 4% | 5% | 0% | −3% |
| Grinding time | 3380 | 3530 | 3640 | 3530 | 3450 |
| 60 min. | | | | | |
| Δ_{ref} | | 4% | 8% | 4% | 2% |
| Grinding time | 4170 | 4340 | 4380 | 4310 | 4230 |
| 90 min. | | | | | |
| Δ_{ref} | | 4% | 5% | 3% | 1% |
| Grinding time | 4450 | 4550 | 4450 | 4510 | 4590 |
| 300 min. | | | | | |
| Δ_{ref} | | 2% | 0% | 1% | 3% |
| Water demand | 26.1 | 28.4 | 28.7 | 26.8 | 27.6 |
| [%] | | | | | |
| Δ_{ref} | | 9% | 10% | 3% | 6% |

* based on clinker.

### Comparison of Grinding Aids

Clinker: K-1 with Sulfate Carrier

TABLE 7
Polymers A as grinding aids.

| | Ref. | Ref. | Ref. | | | |
|---|---|---|---|---|---|---|
| Designation | 1-3 | 2-3 | 3-3 | 1-3 | 2-3 | 3-3 |
| Grinding aid | — | TEA | TIPA | A-1 | A-2 | A-3 |
| Concentration | | 0.08 | 0.08 | 0.08 | 0.07 | 0.08 |
| [% by wt] | | | | | | |
| Water demand | 26.7 | 29.7 | 29.8 | 26.4 | 24.8 | 25.6 |
| [%] | | | | | | |
| Δ_{ref} | | +11% | +12% | −1% | −7% | −4% |
| Flow table | 16.4 | 16.4 | 16 | 18.4 | 19.8 | 18.5 |
| spread [cm] | | | | | | |
| Δ_{ref} | | −0% | −2% | +12% | +21% | +13% |
| Air content [%] | 3.0 | 3.4 | 3.6 | 3.0 | 3.1 | 3.2 |
| Δ_{ref} | | +13% | +20% | 0% | +3% | +7% |
| Grinding | 100 | 85 | 85 | 87 | 92 | 90 |
| time₄₅₀₀ [min] | | | | | | |
| Δ_{ref} | | −15% | −15% | −13% | −8% | −10% |

* based on clinker.

### Polymers A/Alkanolamine Mixtures as Grinding Aids (CAGA)

Clinker: K-1 with Sulfate Carrier

TABLE 8
Polymer A/alkanolamine mixtures as grinding aids.

| Grinding aid | | A-1/TEA | | | | A-1/TIPA | | | |
|---|---|---|---|---|---|---|---|---|---|
| Designation | Ref. 1-4 | 5-4a | 5-4b | 5-4c | 5-4d | 6-4a | 6-4b | 6-4c | 6-4d |
| A-1 [% by wt.] | — | 0.08 | 0.0536 | 0.0264 | | 0.008 | 0.0536 | 0.0264 | |
| TEA [% by wt.] | — | | 0.0264 | 0.0536 | 0.08 | | | | |
| TIPA [% by wt.] | — | | | | | | 0.0264 | 0.0536 | 0.08 |
| A-1/trialkanolamine | | 3/0 | 2/1 | 1/2 | 0/3 | 3/0 | 2/1 | 1/2 | 0/3 |
| Water demand [%] | 26.7 | 26.4 | 28.0 | 28.4 | 29.7 | 26.4 | 28.0 | 28.2 | 29.8 |
| Δ_{ref} | | −1% | 5% | 6% | 11% | −1% | 5% | 6% | 12% |
| Flow table spread [cm] | 16.4 | 18.4 | 16.8 | 16.9 | 16.4 | 18.4 | 17.2 | 17.1 | 16 |
| Δ_{ref} | | 12% | 2% | 3% | 0% | 12% | 5% | 4% | −2% |
| Air pore content [%] | 3 | 3 | 3.3 | 3.3 | 3.4 | 3 | 3.6 | 3.5 | 3.6 |
| Δ_{ref} | | 0% | 10% | 10% | 13% | 0% | 20% | 17% | 20% |
| Grinding time₄₅₀₀ [min] | 100 | 87 | 84 | 85 | 85 | 87 | 86 | 87 | 85 |
| Δ_{ref} | | −13% | −16% | −15% | −15% | −13% | −14% | −13% | −15% |
| Sieve residue >32 μm [%] | 20.83 | 20.28 | 15.14 | 10.87 | 10.74 | 20.28 | 13.53 | 12.16 | 9.3 |
| Δ_{ref} | | −3% | −27% | −48% | −48% | −3% | −35% | −42% | −55% |
| Compressive strength [N/mm²] | | | | | | | | | |
| After 24 h | 16.1 | 14 | 17 | 19.7 | 18.7 | 14 | 17.8 | 18.9 | 18.4 |
| Δ_{ref} | | −13% | 6% | 22% | 16% | −13% | 11% | 17% | 14% |
| After 2 d | 27 | 23.1 | 26.1 | 30.3 | 30.1 | 23.1 | 27.7 | | 32.2 |
| Δ_{ref} | | −14% | −3% | 12% | 11% | −14% | 3% | | 19% |
| After 7 d | 38.2 | 32.3 | 36.9 | 39.6 | 39 | 32.3 | 39.7 | 38.9 | 39 |
| Δ_{ref} | | −15% | −3% | 4% | 2% | −15% | 4% | 2% | 2% |

* based on clinker.

### Polymers A/Alkanolamine Mixtures as Grinding Aids (CAGA)

Clinker: K-2 with Sulfate Carrier

TABLE 9
Polymer A/alkanolamine mixtures as grinding aids.

| Designation | Ref. 1-5 | Ref. 4-5 | 1-5 | 7-5 | 8-6 |
|---|---|---|---|---|---|
| Grinding aid | — | DEG/TEA | A-1 | A-1/TEA | A-1/TIPA |
| DEG [% by wt.] | | 0.07 | | | |
| TEA [% by wt.] | | 0.002 | | 0.0085 | |
| TIPA [% by wt.] | | | | | 0.0085 |
| A-1 [% by wt.] | | | 0.032 | 0.024 | 0.024 |
| Water demand [%] | 25.2 | 26.2 | 24.4 | 26 | 25.1 |
| Δ_{ref} | | 4% | −3% | 3% | 0% |
| Flow table spread [cm] | 19.3 | 18 | 20 | 19.5 | 19.8 |
| Δ_{ref} | | −7% | 4% | 1% | 3% |
| Air content [%] | 2.8 | 2.9 | 2.7 | 2.8 | 2.8 |
| Δ_{ref} | | 4% | −4% | 0% | 0% |
| Compressive strength [N/mm²] | | | | | |
| after 2 d | 24.8 | 25.1 | 22.1 | 24.5 | 25 |
| Δ_{ref} | | 1% | −11% | −1% | 1% |
| after 28 d | 53.2 | 53.1 | 53.7 | 52.6 | 54.2 |
| Δ_{ref} | | 0% | 1% | −1% | 2% |

* based on clinker.

### Polymers A/Alkanolamine/Alkylene Glycol Mixtures as Grinding Aids (CAGA)

Clinker: K-1 with Sulfate Carrier

TABLE 10
Polymers A/alkanolamine/alkylene glycol mixtures as grinding aids.

| | Ref. 1-6 | 11-1 | 11-2 | 11-3 | 11-4 | 11-5 | 11-6 |
|---|---|---|---|---|---|---|---|
| Grinding aid | — | A-11 | A-11/DEG | A-11/TIPA | A-11-DEG/TIPA | A-11/TEA | A-11/DEG/TEA |
| A-11 [% by wt.] | | 0.08 | 0.04 | 0.04 | 0.04 | 0.04 | 0.04 |
| DEG [% by wt.] | | | 0.04 | | 0.02 | | 0.02 |
| TIPA [% by wt.] | | | | 0.04 | 0.02 | | |
| TEA [% by wt.] | | | | | | 0.04 | 0.02 |
| Water demand [%] | 26.7 | 26.4 | 27.1 | 28.2 | 27.9 | 28.2 | 27.8 |
| Δ_{ref} | | −1% | 1% | 6% | 4% | 6% | 4% |
| Flow table spread [cm] | 16.8 | 19.3 | 18.7 | 18.0 | 18.4 | 18.4 | 18.9 |
| Δ_{ref} | | 15% | 11% | 7% | 10% | 10% | 13% |
| Air content [%] | 3.1 | 3.2 | 3.3 | 3.4 | 3.2 | 3.1 | 3.1 |
| Δ_{ref} | | 3% | 6% | 10% | 3% | 0% | 0% |
| Sieve residue₄₀₀₀ >32 μm [%] | 30.80 | 24.90 | 24.62 | 20.04 | 23.25 | 19.74 | 17.07 |
| Δ_{ref} | | −19% | −20% | −35% | −25% | −36% | −45% |
| Compressive strength [N/mm²] | | | | | | | |
| after 24 h | 11.0 | 9.6 | 9.8 | 11.0 | 11.6 | 13.4 | 13.5 |
| Δ_{ref} | | −13% | −11% | 0% | 5% | 22% | 23% |
| after 2 d | 19.8 | 18.9 | 18.7 | 21.1 | 21.9 | 21.9 | 23.1 |
| Δ_{ref} | | −5% | −6% | 7% | 11% | 11% | 17% |
| after 7 d | 28.4 | 28.3 | 30.3 | 31.8 | 33.4 | 32.4 | 32.5 |
| Δ_{ref} | | 0% | 7% | 12% | 18% | 14% | 14% |
| after 28 d | 42.5 | 41.7 | 43.3 | 43.9 | 45.5 | 46.2 | 47.6 |
| Δ_{ref} | | −2% | 2% | 3% | 7% | 9% | 12% |

* based on clinker.

1. The use of an aqueous composition comprising at least one polymer A of the formula (I) as a cement grinding agent 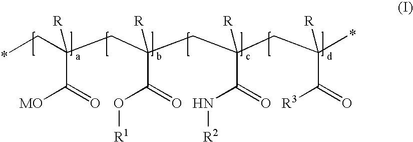
where
M=each independently H⁺, alkali metal ion, alkaline earth metal ion, di- or trivalent metal ion, ammonium ion or organic ammonium group,
R=each R, independently of the others, is hydrogen or methyl,
R¹ and R²=each independently C₁ to C₂₀-alkyl, cycloalkyl, alkylaryl or -[AO]ₙ—R⁴,
where A=C₂- to C₄-alkylene, R⁴=C₁- to C₂₀-alkyl, cyclohexyl or alkylaryl;
and n=2-250,
R³=—NH₂, —NR⁵R⁶, —OR⁷NR⁸R⁹,
where R⁵ and R⁶ are each independently
H or a C₁- to C₂₀-alkyl, cycloalkyl or alkylaryl or aryl group;
or
is a hydroxyalkyl group,
or an
acetoxyethyl (CH₃—CO—O—CH₂—CH₂—) or a
hydroxyisopropyl (HO—CH(CH₃)—CH₂—) or an acetoxyisopropyl group (CH₃—CO—O—CH(CH₃)—CH₂—),
or R⁵ and R⁶ together form a ring,
of which the nitrogen is part, to form a morpholine or imidazoline ring,
where R⁷ is a C₂-C₄-alkylene group,
and R⁸ and R⁹ are each independently a C₁- to C₂₀-alkyl, cycloalkyl, alkylaryl, aryl or a hydroxyalkyl group,
and where a, b, c and d are molar ratios and
a/b/c/d=(0.1-0.9)/(0.1-0.9)/(0-0.8)/0-0.3),
and a+b+c+d=1.

2. The use of an aqueous composition as claimed in claim 1, characterized in that n=8-200, more preferably n=11-150.

3. The use of an aqueous composition as claimed in claim 1, characterized in that
a/b/c/d=(0.1-0.9)/(0.1-0.9)/(0-0.5)/(0-0.1), preferably
a/b/c/d=(0.1-0.9)/(0.1-0.9)/(0-0.3)/(0-0.06).

4. The use of an aqueous composition as claimed in claim 3, characterized in that c+d>0.

5. The use of an aqueous composition as claimed in claim 1, characterized in that the proportion of the polymer A of the formula (I) is from 10 to 90% by weight, in particular from 25 to 50% by weight, based on the weight of the aqueous composition.

6. The use of an aqueous composition as claimed in claim 1, characterized in that the composition is a dispersion.

7. The use of an aqueous composition as claimed in claim 1, characterized in that the composition is a solution.

8. The use of an aqueous composition as claimed in claim 1, characterized in that the aqueous composition comprises further grinding aids or in that the aqueous composition is combined together with further grinding aids.

9. The use of an aqueous composition as claimed in claim 8, characterized in that the further grinding aid is selected from the group comprising glycols, organic amines and ammonium salts of organic amines with carboxylic acids.

10. The use of an aqueous composition as claimed in claim 9, characterized in that the organic amine is a trialkanolamine, especially triisopropanolamine or triethanolamine.

11. The use of an aqueous composition as claimed in claim 1, characterized in that the aqueous composition is added to the clinker such that the polymer A of the formula (I) is 0.001-1.5% by weight, in particular between 0.005 and 0.2% by weight, preferably between 0.005 and 0.1% by weight, based on the clinker to be ground.

12. A process for producing cement, characterized in that an aqueous composition comprising at least one polymer A of the formula (I) is added to the clinker before the grinding and the mixture is then ground to give the cement 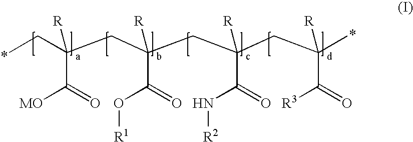
where
M=each independently H⁺, alkali metal ion, alkaline earth metal ion, di- or trivalent metal ion, ammonium ion or organic ammonium group,
R=each R, independently of the others, is hydrogen or methyl,
R¹ and R²=each independently C₁- to C₂₀-alkyl, cycloalkyl, alkylaryl or -[AO]ₙ—R⁴,
where A=C₂- to C₄-alkylene, R⁴=C₁- to C₂₀-alkyl, cyclohexyl or alkylaryl;
and n=2-250,
R³=—NH₂, —NR⁵R⁶, —OR⁷NR⁸R⁹,
where R⁵ and R⁶ are each independently
a C₁- to C₂₀-alkyl, cycloalkyl or alkylaryl or aryl group;
or
is a hydroxyalkyl group,
or an
acetoxyethyl (CH₃—CO—O—CH₂—CH₂—) or a
hydroxyisopropyl (HO—CH(CH₃)—CH₂—) or an acetoxyisopropyl group (CH₃—CO—O—CH(CH₃)—CH₂—),
or R⁵ and R⁶ together form a ring,
of which the nitrogen is part, to form a morpholine or imidazoline ring,
where R⁷ is a C₂-C₄-alkylene group,
and R⁸ and R⁹ are each independently a C₁- to C₂₀-alkyl, cycloalkyl, alkylaryl, aryl or a hydroxyalkyl group,
and where a, b, c and d are molar ratios and
a/b/c/d=(0.1-0.9)/(0.1-0.9)/(0-0.8)/0-0.3),
and a+b+c+d=1.
